(19) United States
(12) Patent Application Publication
(10) Pub. No.: US 2014/0288966 A1
(43) Pub. Date: Sep. 25, 2014

(54) MEDICAL DEVICE SAFETY MANAGEMENT

(71) Applicant: Infosys Limited, Bangalore (IN)

(72) Inventors: Karthikeyan Kaniyur-Subbian, Sathyamangalam (IN); Rashmi Shenoy, Bangalore (IN); Subrahmanya R. Mruthyunjaya, Bangalore (IN)

(73) Assignee: INFOSYS LIMITED, Bangalore (IN)

(21) Appl. No.: 14/199,744

(22) Filed: Mar. 6, 2014

(30) Foreign Application Priority Data
Mar. 21, 2013 (IN) 1233/CHE/2013

(51) Int. Cl. G06Q 50/22; G06Q 30/00

(52) U.S. Cl. CPC G06Q 50/22; G06Q 30/014
USPC 705/3

(57) ABSTRACT

A computer-implemented method of managing medical device safety comprises communicatively coupling a recall portal hosted on a network server to a health network and a computer database of medical records. Further, initiating a medical device recall through the recall portal and the health network. A consumer contact information associated with a medical device to be recalled is queried. A medical recall information is sent to the consumer contact information accessed from the computer database of medical records.

### CROSS-RELATED TO PRIOR APPLICATION

This application claims the benefit of India Patent Application No. 1233/CHE/2013, filed on Mar. 21, 2013, which is incorporated by reference herein.

### FIELD OF TECHNOLOGY

The disclosure relates generally to medical device safety management and, more particularly, to methods, systems and/or apparatus to recall medical devices.

### BACKGROUND

Medical devices of the present era have a large user base. The goal of any medical device is to help improve the health of a patient using the device. Like other devices, medical devices are prone to faults.

Faults detected in the operation of medical devices before being used by consumers may be rectified before being supplied to the consumers. However, if the fault in the medical device is detected after the medical device is supplied to the patient, there exists no efficient method to recall medical devices after the medical devices are supplied to the consumers.

### SUMMARY

Disclosed are a method, an apparatus and/or a system of a medical device safety management.

In some embodiments, a medical device safety management system has medical device identification, a health network, a computer database of medical records, and a recall portal. In some embodiments, the recall portal is communicatively coupled to the health network and the database of medical records. In some embodiments, a device recall message is sent through the recall portal onto the health network. In some embodiments, a consumer is associated with medical device identification. In some embodiments, the device recall message is sent to a contact detail associated with a consumer identified based on a query of the computer database of medical records.

In some embodiments, a device recall message is sent to a consumer that is associated with a medical device identification that is indicated in the device recall message. In some embodiments, the health network is computer network that communicatively couples health service providers, health service regulators, medical device manufacturers and health service consumers. In some embodiments, means for querying the computer database of medical records based on the medical device identification sent through the recall message. In some embodiments, means for contacting the consumer through one of a short message service, electronic mail, voice call, social media and a pre-recorded voice message.

In accordance with some embodiments, in a computer-implemented method of managing medical device safety is disclosed. In the method, a recall portal hosted on a network server is coupled to a health network and a computer database of medical records. A medical device recall is initiated through the recall portal and the health network. A consumer contact information associated with a medical device is queried. The consumer contact information is located on the computer database of medical records. A medical recall information is sent to the consumer contact information accessed from the computer database of medical records.

The methods and systems disclosed herein may be implemented in any means for achieving various aspects, and may be executed in a form of a machine-readable medium embodying a set of instructions that, when executed by a machine, cause the machine to perform any of the operations disclosed herein. Other features will be apparent from the accompanying drawings and from the detailed description that follows.

### BRIEF DESCRIPTION OF THE DRAWINGS

The embodiments of this invention are illustrated by way of example and not limitation in the figures of the accompanying drawings, in which like references indicate similar elements and in which:

FIG. 1 is a schematic view of a medical device safety management system, according to one or more embodiments.

FIG. 2 is a process flow diagram detailing the operation of a medical device safety management system, according to one or more embodiments.

Other features of the present embodiments will be apparent from the accompanying drawings and from the detailed description that follows.

### DETAILED DESCRIPTION

Example embodiments, as described below, may be used to provide a method, an apparatus and/or a system of medical device safety management. Although the present embodiments have been described with reference to specific example embodiments, it will be evident that various modifications and changes may be made to these embodiments without departing from the broader spirit and scope of the various embodiments.

According to one or more embodiments, a medical device safety management system may include a medical device identification, a health network, a computer database of medical records, and a recall portal. The recall portal may be communicatively coupled to the health network and the database of medical records. A device recall message may be sent through the recall portal onto the health network. A consumer may be associated with a medical device identification. The device recall message may be sent to a contact detail associated with a consumer identified based on a query of the computer database of medical records.

In an example embodiment, a device recall message may be sent to a consumer that is associated with a medical device identification that is indicated in the device recall message. Further, a health network may be a computer network that communicatively couples health service providers, health service regulators, medical device manufacturers and health service consumers.

In another example embodiment, a medical device safety management system may include a means for querying a computer database of medical records based on a medical device identification sent through a recall message. Further, the medical device safety management system may include a means for contacting the consumer through one of a short message service, electronic mail, voice call, social media and a pre-recorded voice message.

In an example embodiment, a medical device safety management system may include mapping medical device identification with a registry. The registry may include details of health systems and services on a computer network of health information. The mapping may reveal a set of details of medical device providers that have the medical device identification of devices associated with patients registered with the computer network of health information. Further, a result of data from the computer network of health information may be obtained by filtering data based on the medical device identification. Thus, a device associated with the medical device identification may be recalled. Lists of medical devices that may have to be recalled are similarly recalled by mapping each medical device's medical device identification with the registry.

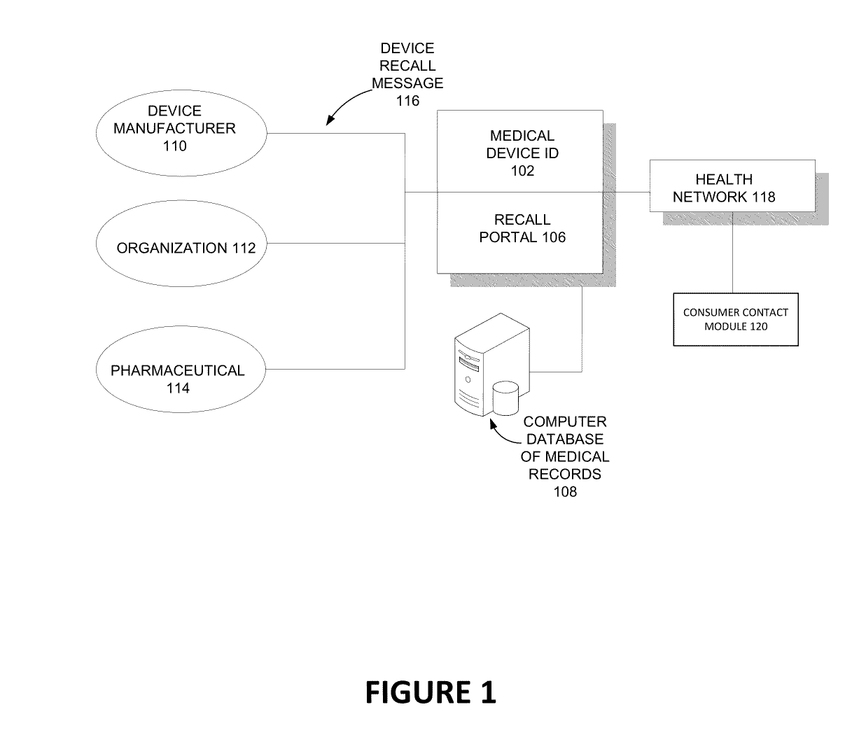

FIG. 1 shows a medical device safety management system, according to one or more embodiments. In certain embodiments, a medical device safety management system may include device recall message 116 initiators such as a device manufacturer 110, organization 112 such as governmental regulatory bodies, and a pharmaceutical 114. The device recall message 116 may be mapped onto a medical device id (identification) 102 that is associated with a recall portal 106. The recall portal 106 and the medical device id 102 may be communicatively coupled to a computer database of medical records 108. Based on mapping of the device recall message 116 onto the medical device id 102, a consumer of a medical device associated with the medical device identification may be contacted based on details queried from a consumer contact module that is coupled to a health network 118. The health network 118 may be a computer based national network health information.

In one or more embodiments, organization 112 may be associated with a database of medical device manufacturers. The health network 118 may be associated with a list of recalled medical device id 102. Further, the health network 118 may be used to access the database of medical device manufacturers and the list of recalled medical device id 102.

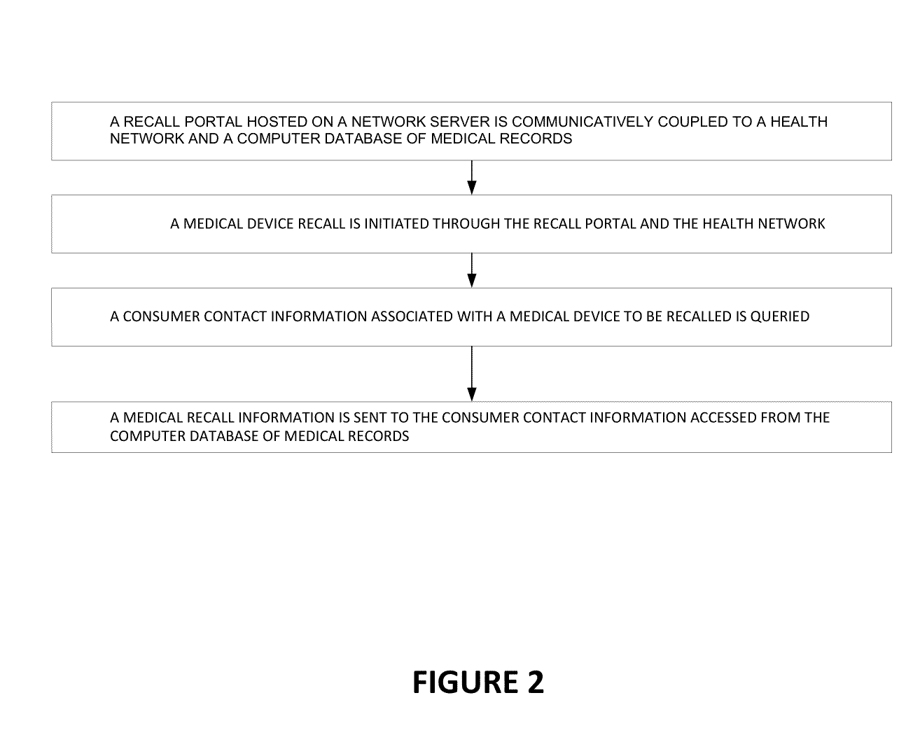

FIG. 2 shows a process flow diagram illustrating the working of a medical device safety management system, according to one or more embodiments. In certain embodiments, a recall portal hosted on a network server may be communicatively coupled to a health network and a computer database of medical records. Further, a medical device recall may be initiated through the recall portal and the health network. A consumer contact information associated with a medical device to be recalled may be queried. Medical recall information may be sent to the consumer contact information accessed from the computer database of medical records.

In one or more embodiments, a method of medical safety management system may include means of recording a consumer reporting to an entity associated with a health network, completing a recall by reclaiming a medical device from the consumer and logging the recall as complete on the health network.

In an example embodiment, payments made as an effect of the recall towards the recalled medical device may be onto a medical device safety management system.

In another example embodiment, a tracking module may determine a stage of recall being executed at a time a request to track the medical device recall.

In one or more embodiments, a medical device safety management system may include a medical device identification, a health network, a computer database of medical records and a recall portal. The recall portal may be communicatively coupled to the health network and the database of medical records. A device recall message may be sent through the recall portal onto the health network. A consumer may be associated with a medical device identification. The device recall message may be sent to a contact detail associated with a consumer identified based on a query of the computer database of medical records.

Further, the medical device safety management system may include the device recall message that is sent to the consumer. The device recall message may be associated with a medical device identification that is indicated in the device recall message.

Still further, the health network is computer network that communicatively may couple health service providers, health service regulators, medical device manufacturers and health service consumers.

The medical device safety management system may further include a means for querying the computer database of medical records based on the medical device identification sent through the recall message.

Also, the medical device safety management system may include means for contacting the consumer through one of a short message service, electronic mail, voice call, social media and a pre-recorded voice message.

In one or more embodiments, a computer-implemented method of managing medical device safety may include communicatively coupling a recall portal hosted on a network server to a health network and a computer database of medical records, initiating a medical device recall through the recall portal and the health network, and querying a consumer contact information associated with a medical device to be recalled.

In one or more embodiments, the consumer contact information may be located on the computer database of medical records. Further, the computer-implemented method of managing medical device safety may include sending a medical recall information to the consumer contact information accessed from the computer database of medical records.

The device recall message is sent to the consumer that may be associated with a medical device identification that is indicated in the device recall message.

In one or more embodiments, the health network is computer network that communicatively may couple health service providers, health service regulators, medical device manufacturers and health service consumers.

A computer-implemented method of managing medical device safety may further include means for querying the computer database of medical records based on the medical device identification sent through the recall message and another means for contacting the consumer through one of a short message service, electronic mail, voice call, social media and a pre-recorded voice message.

In one or more embodiments, a non-transitory computer-readable medium having stored thereon instructions for performing a method of managing medical device safety, which, when executed may cause a data processing system to perform steps comprising communicatively coupling a recall portal hosted on a network server to a health network and a computer database of medical records, initiating a medical device recall through the recall portal and the health network, querying a consumer contact information associated with a medical device to be

recalled, and sending a medical recall information to the consumer contact information accessed from the computer database of medical records.

Further, the consumer contact information may be located on the computer database of medical records.

Still further, the device recall message may be sent to the consumer that is associated with a medical device identification that is indicated in the device recall message.

Also, the health network is computer network that communicatively may couple health service providers, health service regulators, medical device manufacturers and health service consumers.

In one or more embodiments, the non-transitory computer-readable medium may include means for querying the computer database of medical records based on the medical device identification sent through the recall message and another means for contacting the consumer through one of a short message service, electronic mail, voice call, social media and a pre-recorded voice message.

In one or more embodiments, the non-transitory computer-readable medium may further include a means of recording the consumer reporting to an entity associated with the health network, completing the recall by reclaiming the medical device from the consumer and logging the recall as complete on the health network.

Further, the non-transitory computer-readable medium may include a means of logging payments made as an effect of the recall towards the recalled medical device onto a medical device safety management system and a tracking module to determine a stage of recall being executed at a time a request to track the medical device recall.

Although the present embodiments have been described with reference to specific example embodiments, it will be evident that various modifications and changes may be made to these embodiments without departing from the broader spirit and scope of the various embodiments. For example, the various devices and modules described herein may be enabled and operated using hardware circuitry, firmware, software or any combination of hardware, firmware, and software (e.g., embodied in a machine readable medium). For example, the various electrical structure and methods may be embodied using transistors, logic gates, and electrical circuits (e.g., application specific integrated (ASIC) circuitry and/or in Digital Signal Processor (DSP) circuitry).

In addition, it will be appreciated that the various operations, processes, and methods disclosed herein may be embodied in one or more computer-readable media and/or machine-accessible media compatible with a data processing system (e.g., a computing system or computer devices) as computer-executable instructions causing a computing system to perform the disclosed method. The computer-readable media can be, for example, storage media such as a memory, a transportable medium such as a CD, a DVD, a Blu-Ray™ disc, a floppy disk, or a diskette. Non-transitory computer-readable media (e.g., memory, solid state drives, magnetic media, optical media, or the like) can be implemented.

The acts may be performed in any order (e.g., including using means for achieving the various operations). Various operations discussed above may be tangibly embodied on a medium readable through the recall portal to perform functions through operations on input and generation of output. These input and output operations may be performed by a processor. A computer program embodying the aspects of the exemplary embodiments may be loaded onto the recall portal. The computer program is not limited to specific embodiments discussed above, and may, for example, be implemented in an operating system, an application program, a foreground or background process, a driver, a network stack or any combination thereof. The computer program may be executed on a single computer processor or multiple computer processors. So, any of the systems or method described herein can be implemented in a computing system (e.g., comprising one or more processors coupled to memory). The acts can therefore be performed by such a computing system.

Accordingly, the specification and drawings are to be regarded in an illustrative rather than a restrictive sense.

What is claimed is:

1. A medical device safety management system comprising:
a medical device identification;
a health network;
a computer database of medical records; and
a recall portal;
wherein the recall portal is communicatively coupled to the health network and the computer database of medical records;
wherein a device recall message is sent through the recall portal onto the health network;
wherein a consumer is associated with a medical device identification; and
wherein the device recall message is sent to a contact detail associated with a consumer identified based on a query of the computer database of medical records.

2. The medical device safety management system of claim 1, wherein:
the device recall message is sent to the consumer that is associated with a medical device identification that is indicated in the device recall message.

3. The medical device safety management system of claim 1, wherein:
the health network is a computer network that communicatively couples health service providers, health service regulators, medical device manufacturers and health service consumers.

4. The medical device safety management system of claim 1, further comprising:
means for querying the computer database for medical records based on the medical device identification sent through the device recall message.

5. The medical device safety management system of claim 1, further comprising:
means for contacting the consumer through at least one of a short message service, electronic mail, voice call, social media and a pre-recorded voice message.

6. A method, implemented at least in part by a computer, of managing medical device safety, the method comprising:
communicatively coupling a recall portal hosted on a network server to a health network and a computer database of medical records;
initiating a medical device recall through the recall portal and the health network;
querying a consumer contact information associated with a medical device to be recalled, wherein the consumer contact information is located on the computer database of medical records; and
sending medical recall information to the consumer contact information accessed from the computer database of medical records.

7. The method of managing medical device safety of claim 6, wherein:
the device recall information is sent to a consumer that is associated with a medical device identification that is indicated in the device recall information.

8. The method of managing medical device safety of claim 6, wherein:
the health network comprises a computer network that communicatively couples health service providers, health service regulators, medical device manufacturers and health service consumers.

9. The method of managing medical device safety of claim 6, further comprising:
querying the computer database for medical records based on medical device identification sent through the medical recall information.

10. The method of managing medical device safety of claim 6, further comprising:
contacting a consumer associated with the consumer contact information through at least one of a short message service, electronic mail, voice call, social media and a pre-recorded voice message.

11. A non-transitory computer-readable medium having stored thereon computer-executable instructions which, when executed, cause a data processing system to perform a method of managing medical device safety, the method comprising:
communicatively coupling a recall portal hosted on a network server to a health network and a computer database of medical records;
initiating a medical device recall through the recall portal and the health network;
querying a consumer contact information associated with a medical device to be recalled, wherein the consumer contact information is located on the computer database of medical records; and
sending a medical recall information to the consumer contact information accessed from the computer database of medical records.

12. The non-transitory computer-readable medium of claim 11, wherein:
the medical recall information is sent to a consumer that is associated with a medical device identification that is indicated in the medical recall information.

13. The non-transitory computer-readable medium of claim 11, wherein:
the health network is a computer network that communicatively couples health service providers, health service regulators, medical device manufacturers and health service consumers.

14. The non-transitory computer-readable medium of claim 11, wherein the method further comprises:
querying the computer database for medical records based on the medical device identification sent through the medical recall information.

15. The non-transitory computer-readable medium of claim 11, wherein the method further comprises:
contacting a consumer associated with the consumer contact information through at least one selected from the group consisting of: a short message service, electronic mail, voice call, social media and a pre-recorded voice message.

16. The non-transitory computer-readable medium of claim 11, wherein the method further comprises:
recording the sending of the medical recall information to an entity associated with the health network;
completing the medical device recall by reclaiming the medical device from a consumer; and
logging the medical device recall as complete on the health network.

17. The non-transitory computer-readable medium of claim 16, wherein the method further comprises:
logging payments made as an effect of the medical device recall towards the recalled medical device onto a medical device safety management system.

18. The non-transitory computer-readable medium of claim 11, wherein the method further comprises:
determining a stage of recall being executed at a time a request to track the medical device recall is received.
